(19) United States
(12) Patent Application Publication
(10) Pub. No.: US 2025/0004096 A1
(43) Pub. Date: Jan. 2, 2025

(54) Sensor Arrangement

(71) Applicant: Leuze electronic GmbH + Co. KG, Owen/Teck (DE)

(72) Inventors: Johannes Kazmaier, Kohlberg (DE); Rolf Brunner, Eichenau (DE)

(21) Appl. No.: 18/747,568

(22) Filed: Jun. 19, 2024

(30) Foreign Application Priority Data
Jun. 30, 2023 (DE) 202023103660.0

(51) Int. Cl. G01S 7/02; G01S 7/481; G03B 17/56

(52) U.S. Cl. CPC G01S 7/027; G01S 7/4813; G03B 17/561

(57) ABSTRACT

A sensor arrangement (1) with a sensor (2) having a field of vision (4) and with a primary mount (13) to which the sensor (2) is fastenable. The primary mount (13) forms an adjustment device by means of which the orientation of the field of vision (4) of the sensor (2) is settable. A secondary mount (14) is provided to which the primary mount (13) is fastenable. The secondary mount (14) forms a mechanical protection for the sensor (2), wherein the secondary mount (14) is adaptable to the orientation of the field of vision (4) of the sensor (2).

### CROSS REFERENCE TO RELATED APPLICATIONS

This application claims the priority of DE 202023103660.0 filed on 2023 Jun. 30; this application is incorporated by reference herein in its entirety.

### BACKGROUND

The invention relates to a sensor arrangement.

Such a sensor arrangement generally has a sensor which is used for capturing or detecting objects. In particular, the sensor is used for capturing objects in a monitoring area. Depending on whether the sensor captures an object in the monitoring area or not, the sensor generates an object determination signal which is output to a controller of a plant, for example.

The sensor has a defined field of vision within which the sensor emits radiation into the monitoring area or receives radiation therefrom, for example through reflections on objects to be detected. The field of vision is located on the front side of the sensor.

In a known manner, the sensor is mounted by means of a mounting system on a support such as a wall or on a plant to be monitored. The mounting system allows for an alignment of the sensor, in particular an alignment of the orientation of the field of vision. As soon as the alignment is complete, the sensor is fixed in the adjusted position by means of the mounting system.

To enable an alignment of the sensor in the widest possible setting range, the sensor is typically connected to the mounting system only on one side, in particular its rear side.

The remaining part of the sensor is freely accessible. This poses the risk of damages to the sensor, for example by workpieces, vehicles or the like impacting the sensor.

In principle, a stationary cover can be built around the sensor as mechanical protection, wherein the cover preferably surrounds all sides of the sensor with the exception of the front side, where the field of vision of the sensor lies. The disadvantage here, however, is that the orientation of the field of vision of the sensor is fixed by such a cover and can no longer be changed.

In addition, such covers often block access to operating elements on the sensor, which means that setting of the sensor can no longer be performed or can only be performed with great effort.

### SUMMARY

The invention relates to a sensor arrangement (1) with a sensor (2) having a field of vision (4) and with a primary mount (13) to which the sensor (2) is fastenable. The primary mount (13) forms an adjustment device by means of which the orientation of the field of vision (4) of the sensor (2) is settable. A secondary mount (14) is provided to which the primary mount (13) is fastenable. The secondary mount (14) forms a mechanical protection for the sensor (2), wherein the secondary mount (14) is adaptable to the orientation of the field of vision (4) of the sensor (2).

### DETAILED DESCRIPTION

The object of the invention is to provide a mounting system for sensors which has a high level of functionality.

The features of claim 1 are intended to provide a solution to this object. Advantageous embodiments of the invention and appropriate further developments are described in the dependent claims.

The invention relates to a sensor arrangement with a sensor having a field of vision and with a primary mount to which the sensor is fastenable. The primary mount forms an adjustment device by means of which the orientation of the field of vision of the sensor is settable. A secondary mount is provided to which the primary mount is fastenable. The secondary mount forms a mechanical protection for the sensor and is adaptable to the orientation of the field of vision of the sensor.

The primary mount and secondary mount provide a mounting system for sensors which ensures a high level of functionality with a compact design.

The primary mount forms an adjustment device by means of which a flexible, simple adjustment of a sensor is made possible. During an adjustment process, the orientation of the field of vision of the sensor mounted on the primary mount can be set as required by actuating the primary mount and setting it accordingly. After adjustment, the primary mount with the sensor is fixed in the desired position.

According to the invention, a secondary mount is provided in addition to the primary mount, with which secondary mount mechanical protection of the sensor is achieved, i.e. the secondary mount protects the sensor against mechanical influences. In particular, the secondary mount prevents objects such as workpieces, vehicles and the like from directly impacting the sensor, thereby avoiding damage to the sensor. The secondary holder is formed in such a way that it absorbs the impact loads so that the sensor does not come into contact with impacting objects.

An essential aspect of the invention consists in adapting the secondary mount to the orientation of the field of vision of the sensor set with the primary mount. The secondary mount is thus adapted to the set orientation of the field of vision of the sensor, so that the secondary mount ensures the mechanical protective effect of the sensor for different sensor orientations without impairing the field of vision of the sensor.

According to an advantageous embodiment of the invention, the secondary holder is formed with a plurality of parts. At least one part of the secondary mount is adaptable to the orientation of the field of vision of the sensor.

This is an efficient construction form, since it is not necessary to adapt the entire secondary mount to the current orientation of the sensor.

Particularly advantageously, the secondary holder has a fastening element that is formed for fastening to a support. The secondary holder has a protective element which is positionally alterable on the fastening element.

Adapted to this, the primary mount has a connecting element firmly connected to the secondary mount and a sensor holder accommodating the sensor, wherein the position of the sensor holder relative to the connecting element is settable.

The fastening element of the secondary mount is used to fasten the entire mounting system to a support such as a wall of a building or a plant. Using the fastening element, the secondary mount itself is fastened to the support. By means of the connecting element, the primary mount is firmly connected to the fastening element of the secondary mount and thus also to the support.

By adjusting the position of the sensor holder relative to the connecting element, the orientation of the field of vision of the sensor can be set. Adapted to this, the protective element of the secondary mount can be altered relative to the fastening element so that the sensor is protected against mechanical influences by the protective element, but the protective element does not impair the field of vision. In their end position, the sensor holder and the protective element are fixed in position.

Advantageously, the sensor holder is rotatable about an axis. The rotatability of the sensor holder enables easy adjustment of the sensor.

According to a constructively advantageous embodiment, the fastening element is a fastening angle.

Adapted to this, the protective element is formed in the form of a bracket.

The fastening angle is fastened to the support using a first angle segment. The bracket forming the protective element is mounted on the second angle segment, which is preferably oriented perpendicular to the first angle segment. The bracket is essentially formed in a U-shape and has two legs connected by a middle part. The free ends of the legs are fastened to the second angle segment.

The legs and the middle part extend over the sensor holder with the sensor and thus protect the sensor against damage.

The alterability of the position of the protective element is advantageously realized in that the protective element is mounted rotatably about an axis of rotation.

Advantageously, the protective element can be locked in discrete rotational positions on the fastening element.

For this purpose, in one segment of the fastening element there are two rows of holes arranged concentrically in relation to a rotational point or concentrically arranged oblong holes. A fixing element connectable to the underside of the protective element can be inserted into at least one hole in a row of holes or into at least one oblong hole for locking a rotational position of the protective element.

The rows of holes can be arranged along circular arc segments. The holes in the row of holes can be formed as circular holes or oblong holes. The fixing elements can be formed in the form of screws.

The length of the rows of holes determines the setting range, which is preferably ±60°, particularly preferably ±40°.

The setting range is advantageously adapted to the setting range of the rotations of the sensor holder of the primary mount.

The protruding of at least one edge of the secondary holder protects the sensor in the primary holder from mechanical impacts caused by passing people or objects on passing vehicles, even if the secondary holder is mounted rotated about one or two axes.

Another advantage is that the axis about which the sensor holder is rotatable runs parallel to the axis of rotation of the protective element. This allows the rotational position of the protective element to be precisely adapted to the rotational position of the sensor holder.

According to an alternative embodiment, the sensor holder is tilt-alterable in two spatial directions.

In this case, as well, the alterability of the protective element is adapted to the alterability of the sensor holder in such a way that the protective element always protects the sensor holder with the sensor against mechanical damage.

According to an advantageous further development, the sensor holder with the sensor is not only rotatable about the axis. In addition, the sensor is mounted pivotably about a pivot axis on the sensor holder and the sensor holder about a plate about the axis X.

Advantageously, the pivot axis runs perpendicular to the longitudinal axis of the sensor holder.

This allows the position of the sensor to be altered in two or three spatial directions.

Adapted to this, the protective element is formed with a plurality of parts. An upper part of the protective element is pivotable with respect to a pivot axis relative to a lower part of the protective element, which lower part is connected to the fastening element. Expediently, the pivot axis runs perpendicular to the axis of rotation.

The protective element can thus be adapted exactly to the position of the sensor mounted on the sensor holder for protecting the sensor against mechanical damage.

Since only the secondary mount needs to provide protection against mechanical loads, the secondary mount advantageously consists of a more stable material than the primary mount.

For example, the primary mount consists of a plastic and the secondary mount of a metallic material.

Of course, other material combinations are also conceivable. For example, the secondary mount may consist of a harder, more resistant plastic than the primary mount.

According to an advantageous embodiment, the sensor is a radar sensor.

Alternatively, the sensor is an optical sensor.

In particular, the optical sensor is a LIDAR sensor or a camera sensor.

According to an advantageous embodiment, the sensor is a safety sensor.

The safety sensor can be used in safety applications, in particular in the field of personal protection, and has a fail-safe design for this purpose.

### BRIEF DESCRIPTION OF THE DRAWINGS

The invention is explained below on the basis of the drawings. The Figures show:

FIG. 1: A schematic representation of the sensor arrangement according to the invention.

FIG. 2: A first embodiment example of a sensor for the sensor arrangement according to FIG. 1.

FIG. 3: A second embodiment example of a sensor for the sensor arrangement according to FIG. 1.

FIG. 4: An embodiment example of a mounting system for the sensor arrangement according to FIG. 1 in an exploded view.

FIG. 5: A mounting system according to FIG. 4 in a first adjustment position.

FIG. 6: A mounting system according to FIG. 4 in a second adjustment position.

FIG. 7: A second embodiment example of the mounting system.

FIG. 8: A third embodiment example of the mounting system.

### DETAILED DESCRIPTION OF THE PREFERRED EMBODIMENTS

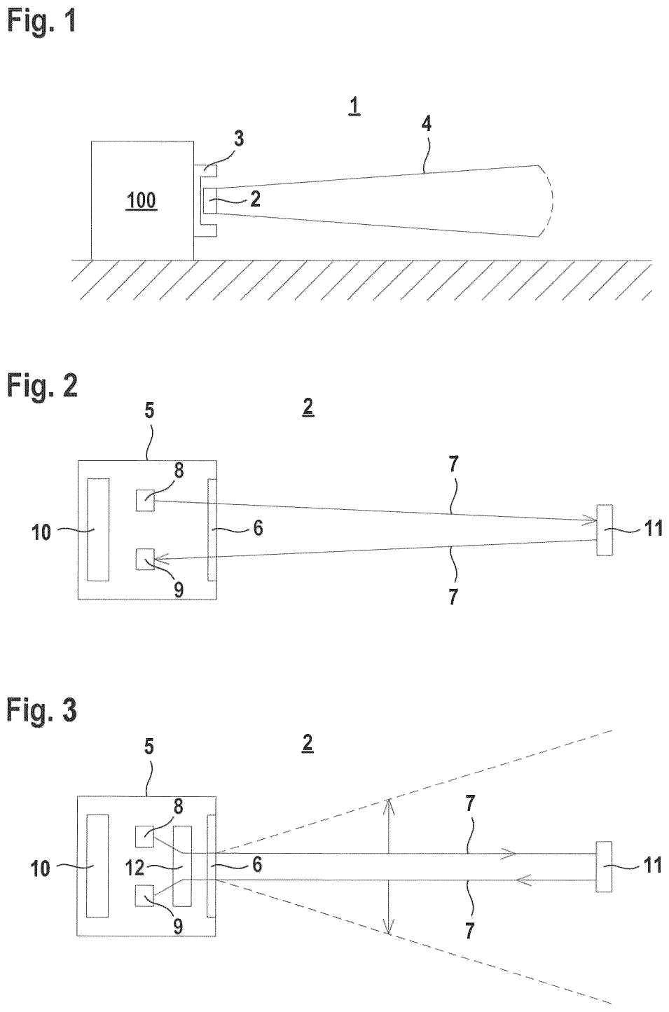

FIG. 1 schematically shows an embodiment example of the sensor arrangement 1 according to the invention. The sensor arrangement 1 has a sensor 2, which is mounted on a plant 100 by means of a mounting system 3, so that a monitoring area in front of the plant 100 can be monitored with the sensor 2. The sensor 2 has a field of vision 4 within which object detection can be carried out.

The sensor 2 is adjustably mounted on the mounting system 3. In addition, the mounting system 3 offers mechanical protection against damage.

FIG. 2 shows a first embodiment example of the sensor 2 of the sensor arrangement 1 according to the invention. The sensor 2 has a housing 5 in which the sensor components of the sensor 2 are integrated. A front screen 6 is located in the front wall of the housing 5. The sensor 2 comprises a transmitter unit 8 emitting radiation 7, a receiver unit 9 receiving radiation 7 and an evaluation unit 10 for evaluating received signals of the receiver unit 9.

The radiation 7 emitted by the transmitter unit 8 in a fixed direction is guided through a front screen 6 into the monitoring area. Radiation 7 reflected by an object 11 is guided back to the receiver unit 9. In the evaluation unit 10, an object detection signal is generated depending on the received signals of the receiver unit 9, which signal in particular indicates whether an object 11 is present in the monitoring area or not.

The aperture angle of the radiation 7 and/or the viewing angle range of the receiver unit 9 determines the field of vision 4 of the sensor 2.

The sensor 2 can be formed as a distance sensor, wherein a pulse transit time method can be used to determine the distance.

The sensor 2 can be formed as a radar sensor. In this case, the transmitter unit 8 is made up of a transmitting antenna and the receiver unit 9 is made up of a receiving antenna.

The sensor 2 can also be an optical sensor 2. In this case, the transmitter unit 8 consists of at least one transmitter emitting light beams, the receiver unit 9 of at least one receiver receiving light beams. The optical sensor 2 can also be formed as a camera sensor. In this case, the receiver unit 9 consists of a matrix arrangement of receiving elements.

FIG. 3 shows a further embodiment of the sensor 2. The sensor 2 according to FIG. 3 is further developed compared to the embodiment according to FIG. 2 in that a deflection unit 12 is present, with which the radiation 7 is periodically guided within a detection area which defines the field of vision 4 of the sensor 2.

The sensor 2 can again be formed as a radar sensor or optical sensor 2, wherein the optical sensor 2 has only one receiver as the receiver unit 9.

In general, the sensor 2 can be formed as a safety sensor which is designed for use in safety applications. For this purpose, the safety sensor has a fail-safe design. This can be realized by a redundant evaluation unit 10, for example in the form of two computer units monitoring each other cyclically.

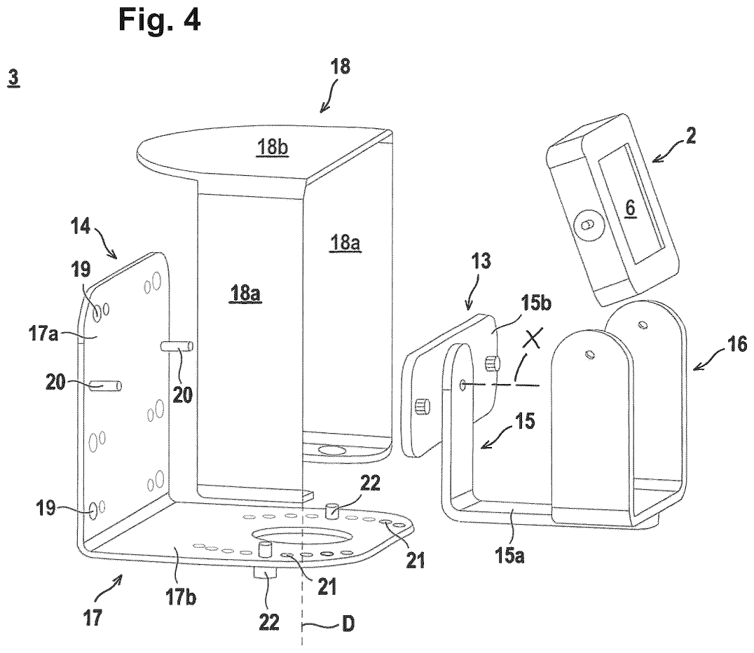

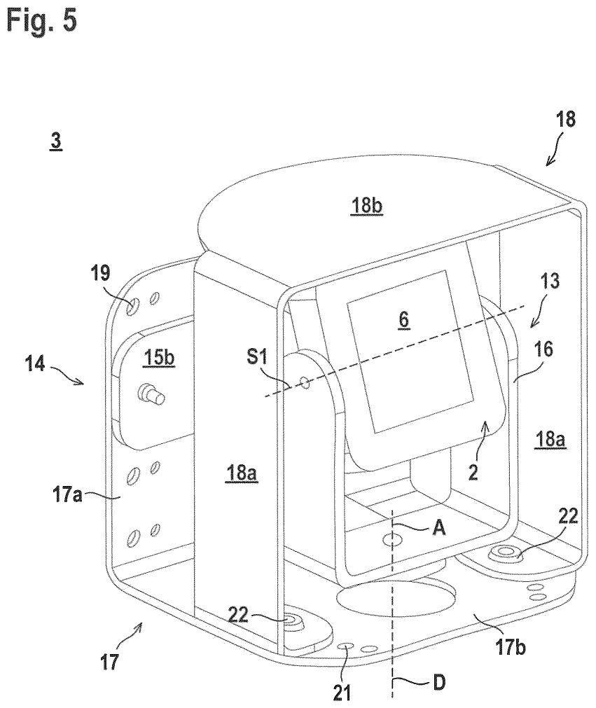

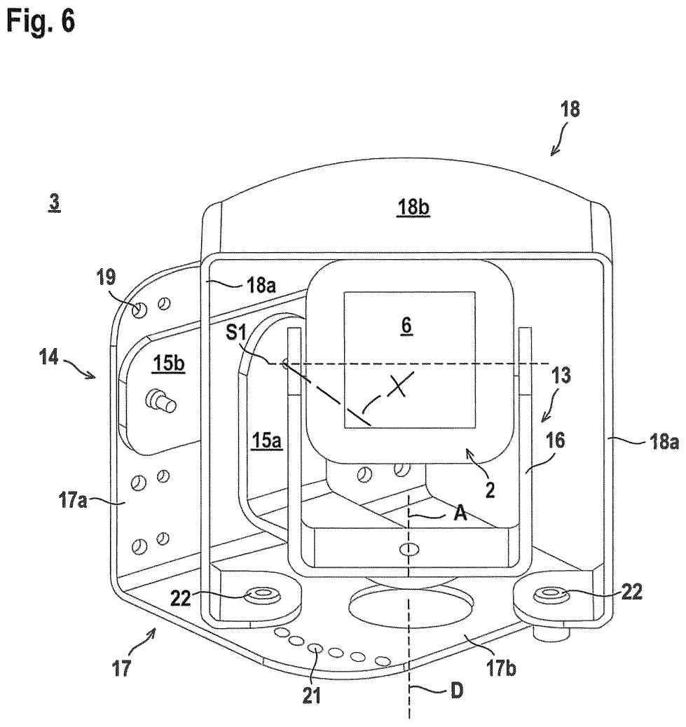

FIG. 4 shows an exploded view of the components of a first embodiment example of the mounting system 3 of the sensor arrangement 1 according to the invention. FIGS. 5 and 6 show the assembled mounting system 3 in different adjustment positions.

The mounting system 3 comprises a primary mount 13, which forms an adjustment device for the sensor 2, and a secondary mount 14, which ensures mechanical protection for the sensor 2.

Advantageously, the secondary mount 14 consists of a more stable material than the primary mount 13.

In particular, the primary mount 13 consists of a plastic and the secondary mount 14 of a metallic material.

The primary mount 13 comprises a connecting element 15 consisting of an angle 15a and a plate 15b fastened to a first arm of the angle 15a. A sensor holder 16 accommodating the sensor 2 can be fastened to the second arm of the angle 15a in such a way that the sensor holder 16 is mounted rotatably about an axis A. The axis A runs in the longitudinal direction of the sensor holder 16. The sensor holder 16 is formed in the form of a bracket.

The first arm of the angle 15a is mounted pivotably about a pivot axis X on the plate 15b.

The sensor 2 itself is mounted pivotably about a pivot axis S1 on the sensor holder 16, wherein the pivot axis S1 runs perpendicular to the axis A. FIGS. 5 and 6 show the sensor 2 in different rotational positions on the sensor holder 16.

The secondary mount 14 comprises a fastening element in the form of a fastening angle 17 and a protective element in the form of a bracket 18.

The fastening angle 17 forming the fastening element is formed for fastening to a support, in this case a wall of the plant 100.

For this purpose, a first angle segment 17a of the fastening angle 17, in which fastening holes 19 are provided for fastening to a wall, is used. The fastening means 20, which may be screws, are intended for fastening the primary holder 13.

A second angle segment 17b of the fastening angle 17 forms a base plate on which the bracket 18 forming the protective element can be fastened in a positionally alterable manner.

For this purpose, rows of holes 21 arranged concentrically in relation to a pivot point are provided in the base plate. The holes 21 in each row of holes run along a circular arc. In the present case, the holes 21 are formed in a circular form. Alternatively, oblong holes can be provided.

This ensures the alterability of the bracket 18 about an axis of rotation D. The axis of rotation D can advantageously coincide with the axis A about which the sensor holder 16 can be rotated. The bracket 18 can be fixed to the base plate in discrete rotational positions. As shown in FIGS. 4 to 6, the bracket 18 is formed in a U-shape, wherein two legs 18a are connected via a middle part 18b. To fix a rotational position of the bracket 18 on the base plate, a fixing element 22 is inserted through a hole 21 in a row of holes of the base plate and connected to the free end of a leg 18a. The fixing elements 22 can be formed by screws.

As FIGS. 5 and 6 show, in an adjustment process the sensor holder 16 with the sensor 2 can be set and fixed in position in a suitable rotational position by rotation about the axis A, wherein FIGS. 5 and 6 show different rotational positions of the sensor holder 16. Sensor 2 is thus adjusted to its target position.

Adapted to this, the protective element, i.e. the bracket 18 of the secondary mount 14, is brought into a corresponding rotational position, so that the bracket 18 extends over the sensor holder 16 with the sensor 2 and protects it mechanically. Since the rotational position of the bracket 18 is adapted to the rotational position of the sensor holder 16 with the sensor 2, the front side and thus the field of vision 4 of the sensor 2 is not blocked by the bracket 18.

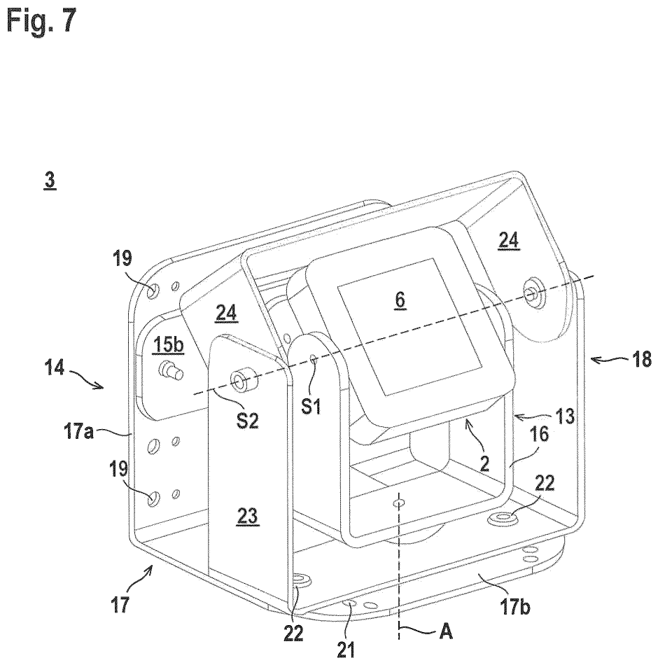

FIG. 7 shows a further development of the embodiment according to FIG. 6 in such a way that the protective element consists of a U-shaped lower bracket part 23 and a U-shaped upper bracket part 24, which are hingedly connected to each other so that the upper bracket part 24 can be pivoted with respect to a pivot axis S2 with respect to the lower bracket part 23.

The pivot axis S2 coincides with the pivot axis S1 of the sensor 2.

Corresponding to the bracket 18 of the embodiments according to FIGS. 4 to 6, the lower bracket part 23 can be fastened to the base plate in discrete rotational positions by means of the fixing elements 22.

This protective element ensures further improved mechanical protection of the sensor 2, as the tilt of the upper bracket part 24 can be adapted to the tilt of the sensor 2.

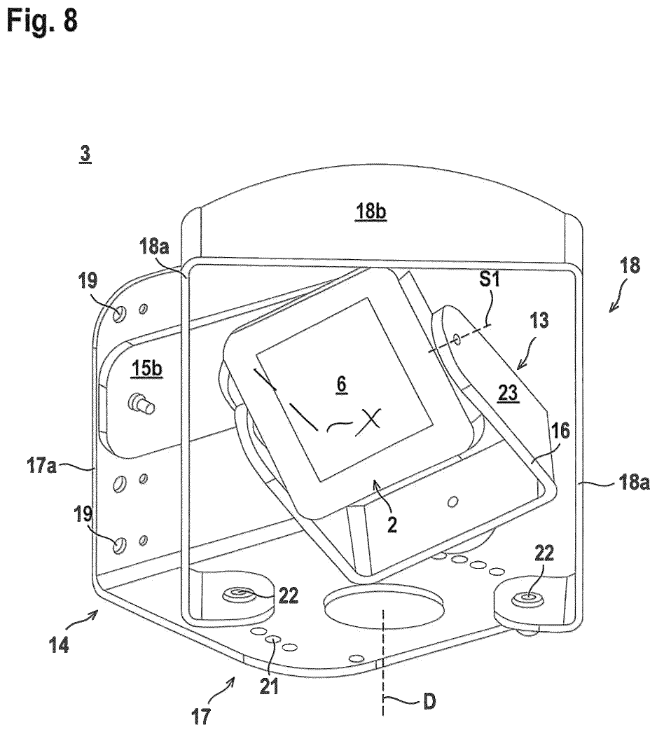

FIG. 8 shows a variant of the embodiment according to FIGS. 4 to 6, in which the sensor holder 16 with the sensor 2 can be tilted in two spatial directions.

### LIST OF REFERENCE NUMERALS

(1) Sensor arrangement

### (2) Sensor

(3) Mounting system
(4) Field of vision

### (5) Housing

(6) Front screen

### (7) Radiation

(8) Transmitter unit
(9) Receiver unit
(10) Evaluation unit

### (11) Object

(12) Deflection unit
(13) Primary mount
(14) Secondary mount
(15) Connecting element

### (15a) Angle

### (15b) Plate

(16) Sensor holder
(17) Fastening angle

### (17a) Angle Segment

### (17b) Angle Segment

### (18) Bracket

### (18a) Leg

(18b) Middle part
(19) Fastening surface
(20) Fastening means

### (21) Hole

(22) Fixing element
(23) Lower bracket part
(24) Upper bracket part

### (100) Plant

### (A) Axis

(D) Axis of rotation
(S1) Pivot axis
(S2) Pivot axis
(X) Pivot axis

1. A sensor arrangement (1) with a sensor (2) having a field of vision (4) and with a primary mount (13) to which the sensor (2) is fastenable, wherein the primary mount (13) forms an adjustment device by means of which the orientation of the field of vision (4) of the sensor (2) is settable, characterized in that there is a secondary mount (14) to which the primary mount (13) is fastenable, wherein the secondary mount (14) forms a mechanical protection for the sensor (2), and wherein the secondary mount (14) is adaptable to the orientation of the field of vision (4) of the sensor (2).

2. The sensor arrangement (1) according to claim 1, characterized in that the secondary mount (14) is formed with a plurality of parts, wherein at least one part of the secondary mount (14) is adaptable to the orientation of the field of vision (4) of the sensor (2).

3. The sensor arrangement (1) according to claim 2, characterized in that the secondary mount (14) has a fastening element which is formed for fastening to a support, and in that the secondary mount (14) has a protective element which is positionally alterable on the fastening element.

4. The sensor arrangement (1) according to claim 3, characterized in that the fastening element is a fastening angle (17), and/or in that the protective element is formed in the form of a bracket (18).

5. The sensor arrangement (1) according to claim 3, characterized in that the protective element is mounted rotatably with respect to an axis of rotation (D), wherein the protective element is lockable in discrete rotational positions on the fastening element.

6. The sensor arrangement (1) according to claim 5, characterized in that in a segment of the fastening element there are two rows of holes or oblong holes arranged concentrically in relation to a pivot point, wherein a fixing element (22) connectable to the underside of the protective element can be inserted into respectively at least one hole (21) of a row of holes or oblong holes for locking a rotational position of the protective element.

7. The sensor arrangement (1) according to claim 3, characterized in that the protective element is formed with a plurality of parts, wherein an upper part of the protective element is pivotable with respect to a pivot axis (S2) relative to a lower part of the protective element, which lower part is connected to the fastening element.

8. The sensor arrangement (1) according to claim 1, characterized in that the primary mount (13) has a connecting element (15) connected to the secondary mount (14) and a sensor holder (16) accommodating the sensor (2), wherein the position of the sensor holder (16) relative to the connecting element (15) is settable.

9. The sensor arrangement (1) according to claim 8, characterized in that the sensor holder (16) is rotatable about an axis (A), and/or in that the sensor holder (16) is tilt-alterable in two spatial directions.

10. The sensor arrangement (1) according to claim 6, characterized in that the axis (A) runs parallel to the axis of rotation (D) of the protective element, and/or in that the sensor (2) is mounted pivotably about a pivot axis (S1) on the sensor holder (16), wherein the pivot axis (S1) runs perpendicular to the longitudinal axis of the sensor holder (16).

11. The sensor arrangement (1) according to claim 8, characterized in that the connecting element (15) made of an angle (15a) and a plate (15b) is fastened to the secondary mount (14), wherein the angle (15a) with a first arm is mounted pivotably about a pivot axis (X) on the plate (15b), and wherein the sensor holder (16) is mounted on the second arm of the angle (15a).

12. The sensor arrangement (1) according to claim 3, characterized in that sensor positions of the sensor (2) on the primary mount (13) are changeable within predetermined setting ranges, and/or in that setting ranges of the protective element are adapted to the setting ranges of the sensor (2).

13. The sensor arrangement (1) according to claim 1, characterized in that the secondary mount (14) consists of a more stable material than the primary mount (13).

14. The sensor arrangement (1) according to claim 1, characterized in that the sensor (2) is a radar sensor or an optical sensor (2).

15. The sensor arrangement (1) according to claim 1, characterized in that the sensor (2) is a safety sensor.
